(19) United States
(12) Patent Application Publication
(10) Pub. No.: US 2016/0166943 A1
(43) Pub. Date: Jun. 16, 2016

(54) EDUCATIONAL FIGURINE

(71) Applicants: Marshall Roemen, Los Angeles, CA (US); Haley Roemen, Los Angeles, CA (US)

(72) Inventors: Marshall Roemen, Los Angeles, CA (US); Haley Roemen, Los Angeles, CA (US)

(21) Appl. No.: 14/967,685

(22) Filed: Dec. 14, 2015

Related U.S. Application Data
(60) Provisional application No. 62/091,113, filed on Dec. 12, 2014.

(51) Int. Cl. A63H 3/04; G09B 19/00

(52) U.S. Cl. CPC A63H 3/04; G09B 19/00

(57) ABSTRACT

A posable figurine with elongated body, arms, hands, legs, and feet. Internal semi-rigid skeleton allows figurine to be posed while retaining the shape into which it is posed. External semi-flexible or flexible material allows movement of internal skeleton without cracking. Elongated appendages allow figurine to be posed into many shapes, including at least letters of the English alphabet. May be suitable for use with other languages. Fasteners in hands and feet allow figurine to maintain particular shapes. Method of use includes bending figurine into a particular shape. Further method of use includes using at least two fasteners to help create and maintain the posed shape.

### FIELD OF THE INVENTION

This invention relates generally to education and demonstration, and, more specifically, to systems and methods for alphabet letter formation.

### SUMMARY OF THE INVENTION

This invention relates generally to education and demonstration, and, more specifically, to systems and methods for alphabet letter formation.

The present invention is comprised of a bendable figurine having an inner bendable structure and an outer flexible material. The figurine has an extenuated figure with a long body and limbs, which allow the figurine to be bent into each of the letters of the alphabet. The posable toy figurine includes attachment means at the hands and feet in order to aid in the practice of performing several of the invention's particular functions.

One object of the present invention is to bend into and remain as representations of each letter of the English alphabet. Another object of the present invention is to bend into and remain as representations of letters of other Romance Languages, for instance, French, Spanish, Italian, and Portuguese. Another object of the present invention is to provide a method by which the arms, legs and head can are positioned in accordance in order to assist the user in forming each letter. Further advantages of the bendable toy will be clarified through the Detailed Description of the Preferred Embodiment as well as the Drawings.

The foregoing is a summary and thus contains, by necessity, simplifications, generalizations and omissions of detail; consequently, those skilled in the art will appreciate that the summary is illustrative only and is NOT intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Certain embodiments of the present invention are described in detail below with reference to the following drawings:

FIG. 1 is a front view of one embodiment of the EDUCATIONAL FIGURINE.

FIG. 2 is a cross-sectional view thereof.

FIG. 3 is a detailed view of one portion of one embodiment of the EDUCATIONAL FIGURINE.

FIG. 4 is a different detailed view of one portion of one embodiment of the EDUCATIONAL FIGURINE.

FIG. 5 is one representative view of one embodiment of the EDUCATIONAL FIGURINE in the shape of the letter “A”.

FIG. 6 is one representative view thereof in an alternate shape of the letter “A”.

FIG. 7 is one representative view thereof in another alternate shape of the letter “A”.

FIG. 8 is one representative view thereof in the shape of the letter “B”

FIG. 9 is one representative view thereof in an alternate shape of the letter “B”.

FIG. 10 is one representative view thereof in the shape of the letter “C”

FIG. 11 is one representative view thereof in the shape of the letter “D”

FIG. 12 is one representative view thereof in an alternate shape of the letter “D”.

FIG. 13 is one representative view thereof in the shape of the letter “E”

FIG. 14 is one representative view thereof in an alternate shape of the letter “E”.

FIG. 15 is one representative view thereof in the shape of the letter “F”.

FIG. 16 is one representative view thereof in an alternate shape of the letter “F”.

FIG. 17 is one representative view thereof in the shape of the letter “G”.

FIG. 18 is one representative view thereof in an alternate shape of the letter “G”.

FIG. 19 is one representative view thereof in the shape of the letter “H”.

FIG. 20 is one representative view thereof in an alternate shape of the letter “H”.

FIG. 21 is one representative view thereof in the shape of the letter “I”.

FIG. 22 is one representative view thereof in the shape of the letter “J”.

FIG. 23 is one representative view thereof in the shape of the letter “K”.

FIG. 24 is one representative view thereof in the shape of the letter “L”.

FIG. 25 is one representative view thereof in the shape of the letter “M”.

FIG. 26 is one representative view thereof in an alternate shape of the letter “M”.

FIG. 27 is one representative view thereof in the shape of the letter “N”.

FIG. 28 is one representative view thereof in an alternate shape of the letter “N”.

FIG. 29 is one representative view thereof in the shape of the letter “0”.

FIG. 30 is one representative view thereof in an alternate shape of the letter “O”.

FIG. 31 is one representative view thereof in the shape of the letter “P”.

FIG. 32 is one representative view thereof in the shape of the letter “Q”.

FIG. 33 is one representative view thereof in an alternate shape of the letter “Q”.

FIG. 34 is one representative view thereof in the shape of the letter “R”.

FIG. 35 is one representative view thereof in the shape of the letter “S”.

FIG. 36 is one representative view thereof in an alternate shape of the letter “S”.

FIG. 37 is one representative view thereof in the shape of the letter “T”.

FIG. 38 is one representative view thereof in the shape of the letter “U”.

FIG. 39 is one representative view thereof in an alternate shape of the letter “U”.

FIG. 40 is one representative view thereof in the shape of the letter “V”.

FIG. 41 is one representative view thereof in the shape of the letter “W”.

FIG. 42 is one representative view thereof in an alternate shape of the letter “W”.

FIG. 43 is one representative view thereof in the shape of the letter “X”.

FIG. 44 is one representative view thereof in an alternate shape of the letter “X”.

FIG. 45 is one representative view thereof in the shape of the letter “Y”.

FIG. 46 is one representative view thereof in the shape of the letter “Z”.

FIG. 47 is a view of one alternate embodiment of the EDUCATIONAL FIGURINE.

### DETAILED DESCRIPTION

This invention relates generally to education and demonstration, and, more specifically, to systems and methods for alphabet letter formation.

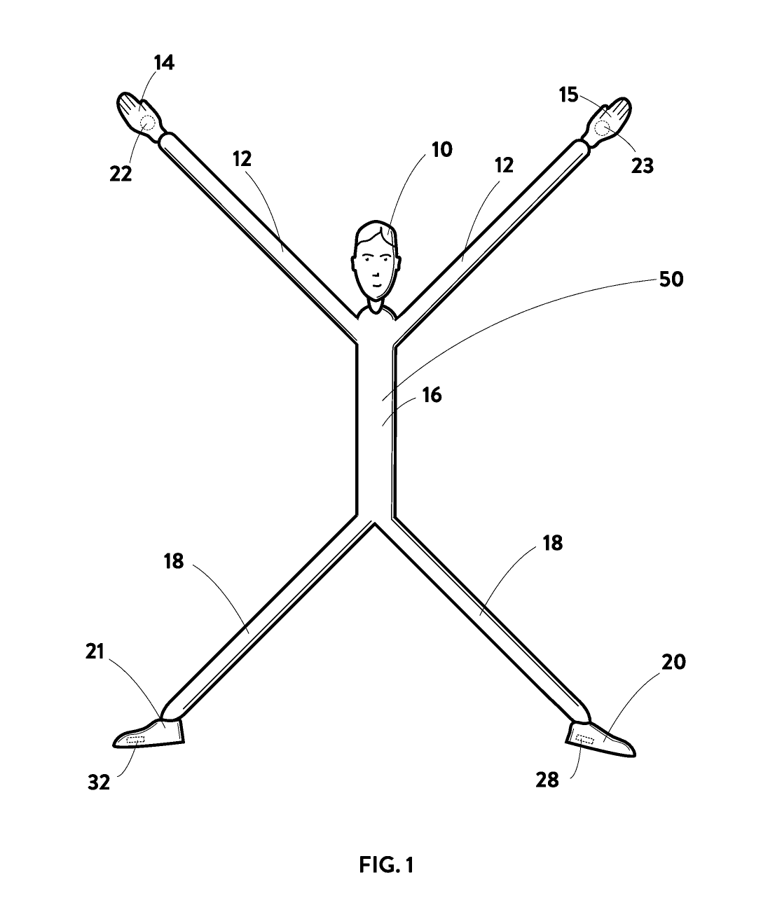

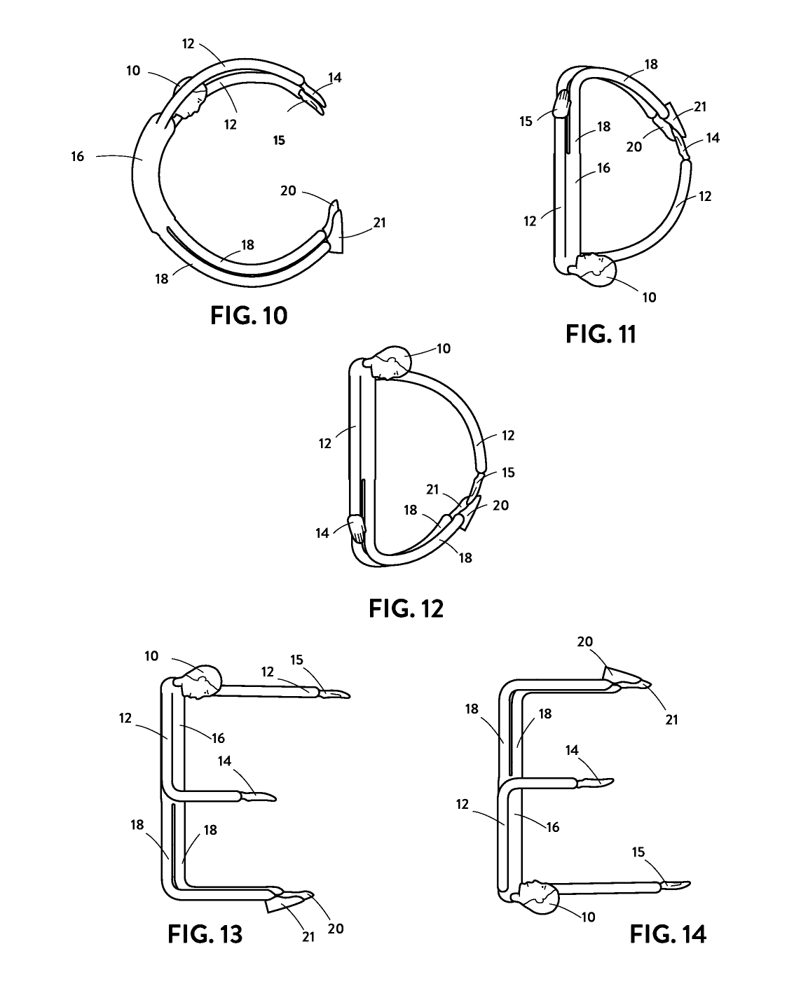

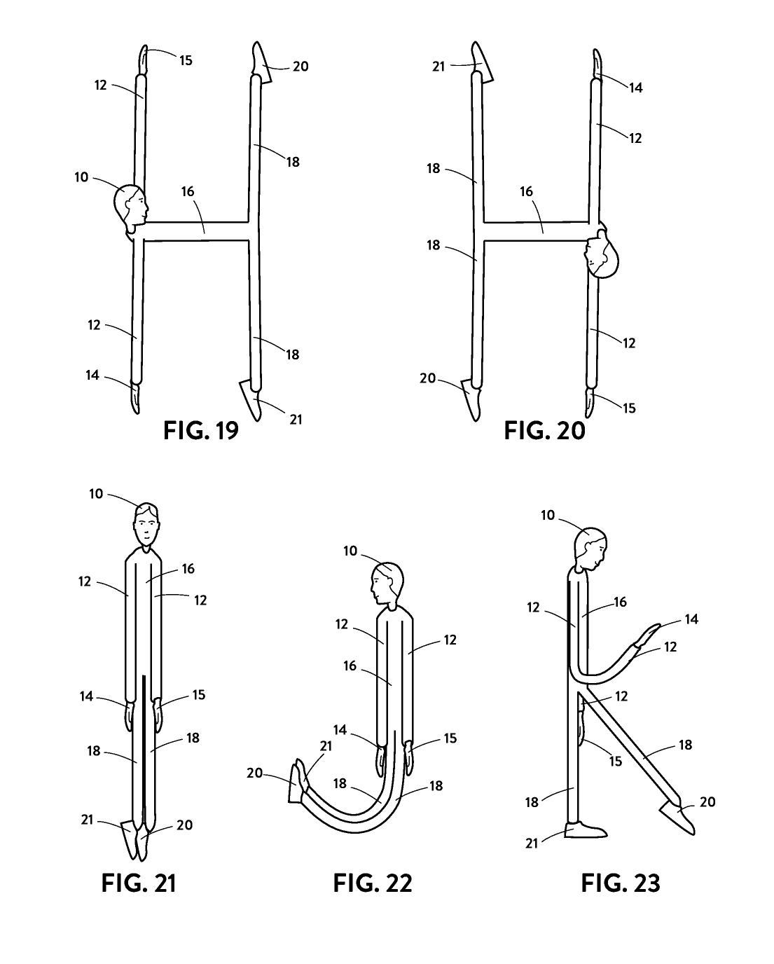

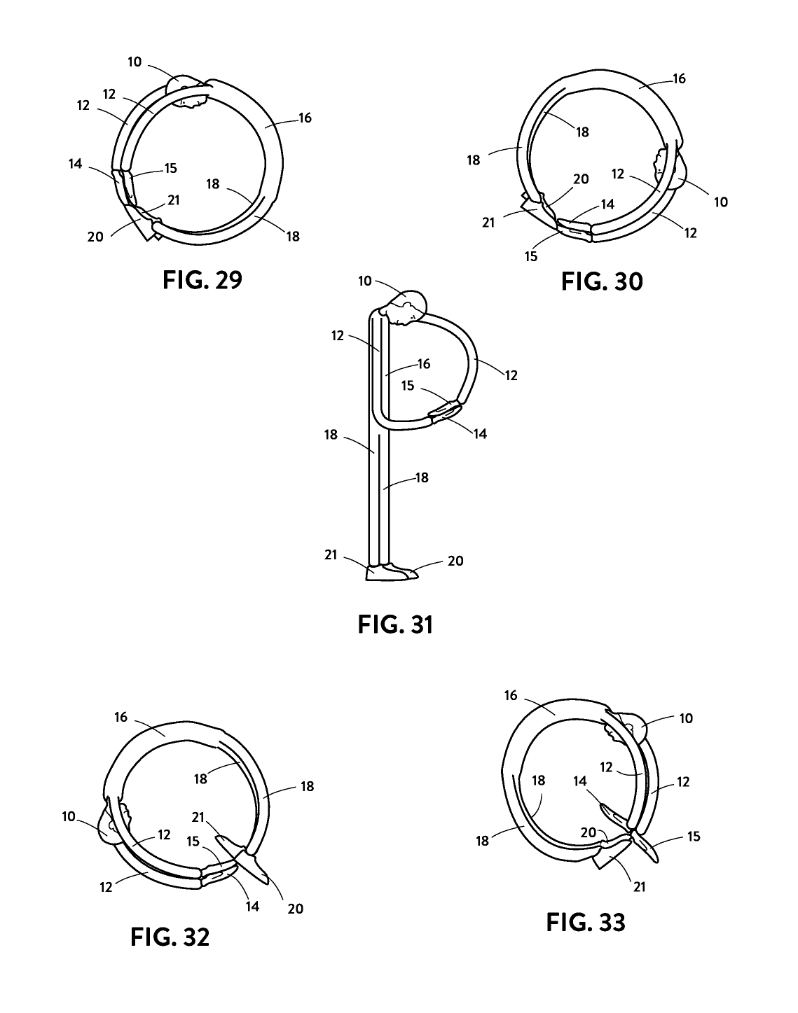

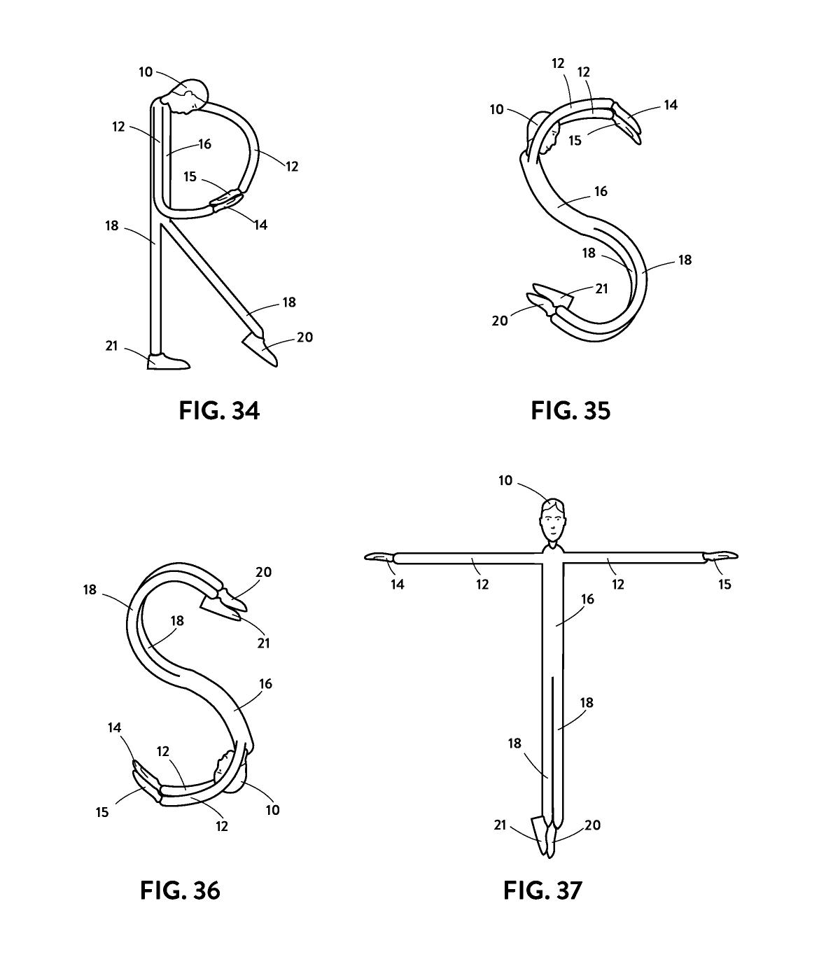

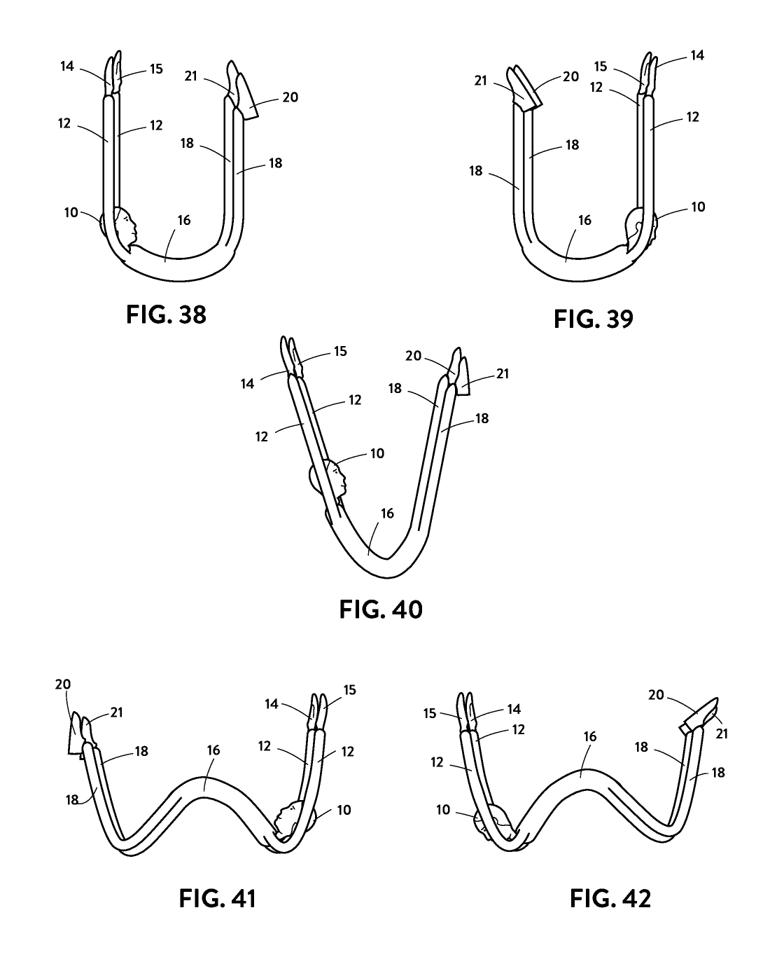

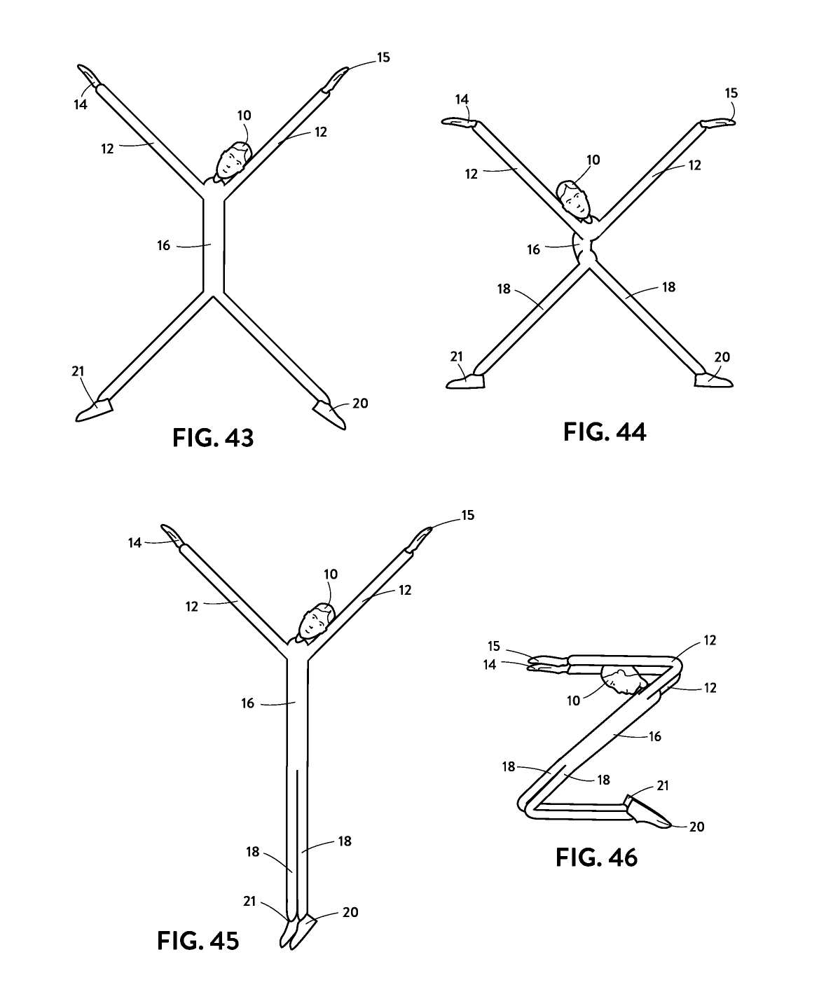

Specific details of certain embodiments of the invention are set forth in the following description and in FIGS. 1-47 to provide a thorough understanding of such embodiments. The present invention may have additional embodiments, may be practiced without one or more of the details described for any particular described embodiment, or may have any detail described for one particular embodiment practiced with any other detail described for another embodiment.

Importantly, a grouping of inventive aspects in any particular “embodiment” within this detailed description, and/or a grouping of limitations in the claims presented herein, is not intended to be a limiting disclosure of those particular aspects and/or limitations to that particular embodiment and/or claim. The inventive entity presenting this disclosure fully intends that any disclosed aspect of any embodiment in the detailed description and/or any claim limitation ever presented relative to the instant disclosure and/or any continuing application claiming priority from the instant application (e.g. continuation, continuation-in-part, and/or divisional applications) may be practiced with any other disclosed aspect of any embodiment in the detailed description and/or any claim limitation. Claimed combinations which draw from different embodiments and/or originally-presented claims are fully within the possession of the inventive entity at the time the instant disclosure is being filed. Any future claim comprising any combination of limitations, each such limitation being herein disclosed and therefore having support in the original claims or in the specification as originally filed (or that of any continuing application claiming priority from the instant application), is possessed by the inventive entity at present irrespective of whether such combination is described in the instant specification because all such combinations are viewed by the inventive entity as currently operable without undue experimentation given the disclosure herein and therefore that any such future claim would not represent new matter.

FIG. 1 is a front view of one embodiment of the EDUCATIONAL FIGURINE. In some embodiments, the figurine 50 includes a head portion 10, a body portion 16, at least one arm portion 12, and at least one leg portion 18. In preferred embodiments, the figurine 50 includes two arm portions 12 and two leg portions 18, each permanently coupled with body portion 16. In some embodiments, each arm 12 includes at least one hand 14 and 15. In some embodiments, hands 14 and 15 include a coupling means 22 and 23. In some embodiments, the coupling means 22 and 23 may be magnets. In other embodiments, coupling means 22 and 23 may be other coupling means, such as hook-and-eye, hook-and-loop, snaps, buttons, etc. Many means of coupling two items could be used for coupling means 22 and 23 without altering the function thereof.

FIG. 1 also shows one embodiment of the figurine 50 including feet portions 20 and 21, each disposed at the end of a leg portion 18. In some embodiments, feet 21 and 20 include a coupling means 28 and 32, respectively. In some embodiments, the coupling means 28 and 32 may be magnets. In other embodiments, coupling means 28 and 32 may be other coupling means, such as hook-and-eye, hook-and-loop, snaps, buttons, etc. Many means of coupling two items could be used for coupling means 28 and 32 without altering the function thereof.

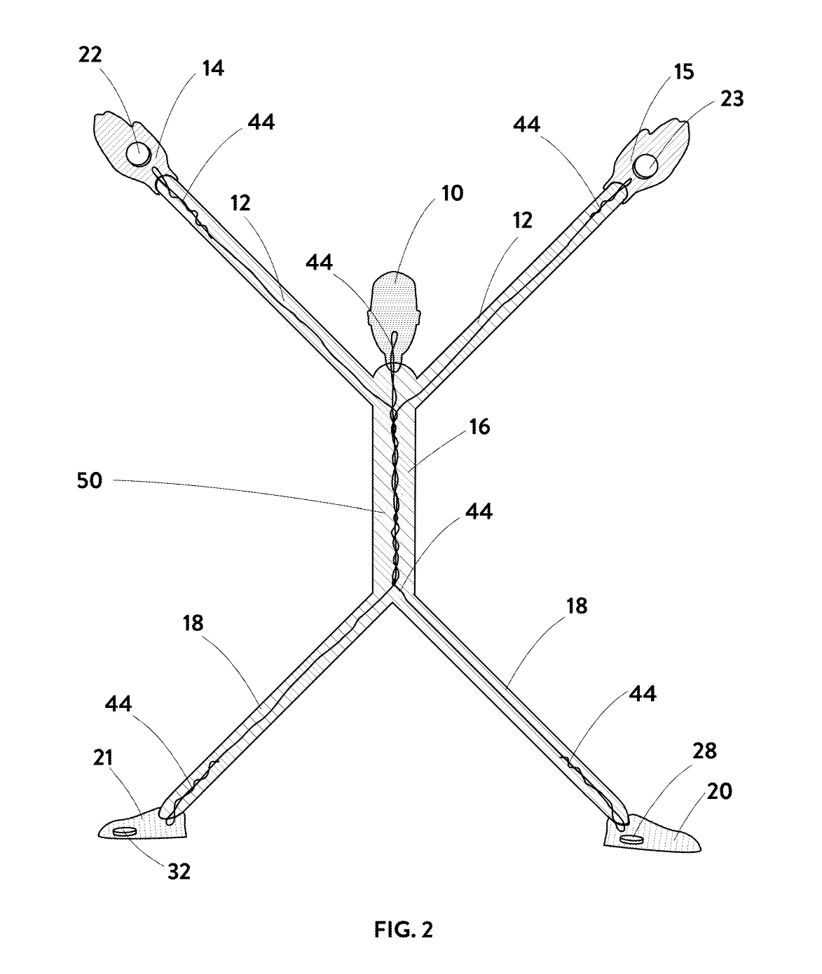

FIG. 2 is a cross-sectional view of one embodiment of the figurine 50. In this figure, coupling means 22, 23, 28, and 32 are shown as embedded in the interior of the figurine 50. This is one non-limiting example, and would apply for coupling means such as magnets, snaps, and buttons. In other embodiments, coupling means 22, 23, 28, and 32 may be disposed on the exterior of the figurine, such as with hook-and-loop coupling means. FIG. 2 also depicts skeleton 44. In some embodiments, skeleton 44 is comprised of a semi-rigid material, such as wire, that allows portions of the figurine 50 to be posed and reposed, but also to retain a shape once the figurine has been posed in that shape. In some embodiments, skeleton 44 may be a single unit extending from head 10 into body 16, arms 12, hands 14 and 15, legs 18, and feet 20 and 21. In other embodiments, skeleton 44 may be several units combined to form the figurine 50, such as one unit for head 10 and body 16, one unit for arms 12, one unit for legs 18, etc. In one further embodiment, skeleton 44 may include flexible joints where head 10 meets body 16, in one non-limiting example, wherein the joints aid in enabling the figurine to be posable. In other embodiments, skeleton 44 may be comprised of a combination of semi-rigid material, rigid material, flexible material, and joints that allow figurine 50 to be posable.

In some embodiments, skeleton 44 is disposed within a flexible or semi-flexible body material, such as fabric, plastic, rubber, or other flexible or semi-flexible materials. In preferred embodiments, the body material may be able to withstand multiple poses without cracking or tearing. In preferred embodiments, the body material may be non-toxic, as this educational toy may be used with children who are inclined to put toys and other items in their mouths. In preferred embodiments, the body material may be washable. In some embodiments, the material disposed over skeleton 44 is of one type, such that the entire outer portion of the figurine is a single unit. In other embodiments, each element, such as head 10 and arms 12, may be comprised of a different material according to the needs of that portion. For instance, head 10 may be comprised of a more rigid material, such as a harder plastic that is safe for children to put in their mouths. At the same time, arm 12 may be comprised of a more flexible material that allows the arm to bend in multiple places.

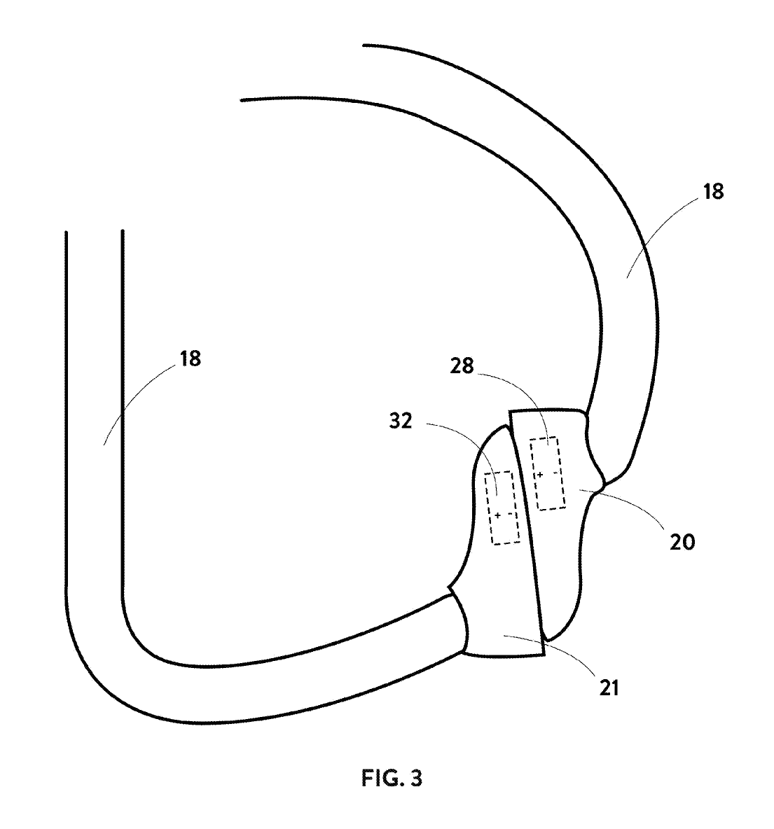

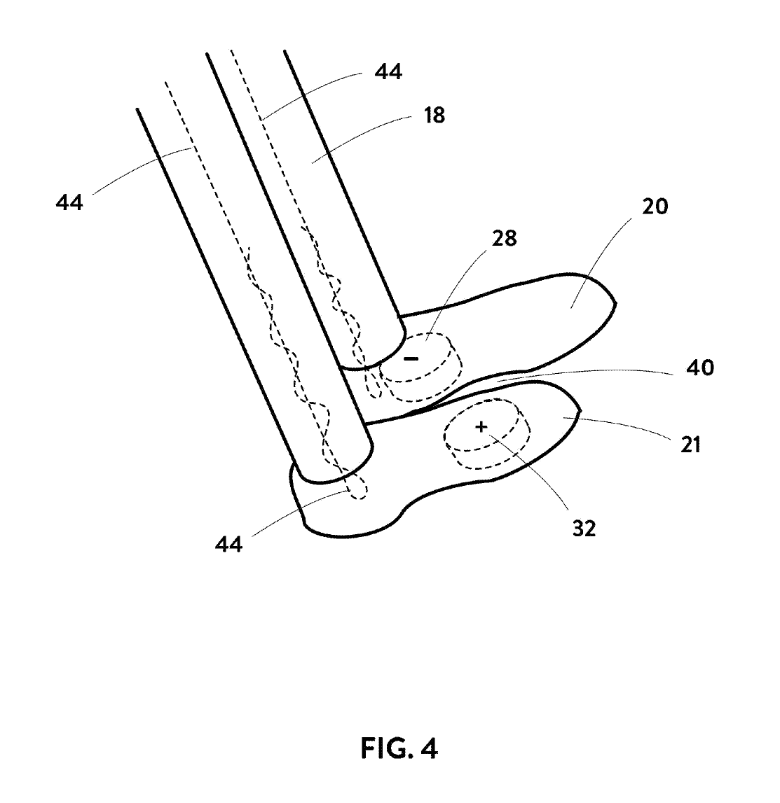

FIG. 3 is a detailed view of one portion of one embodiment of the figurine 50, in which legs 18 have been posed into an exemplary shape. In particular, FIG. 3 shows that a particular placement of fastening means 28 and 32 allows feet 20 and 21, respectively, to be held in a particular position. By disposing fastening means 32 in the toe of foot 21 and fastening means 28 in the heel of foot 20, the feet are brought together in a particular manner to hold a particular shape, namely that the entirety of foot 20 is coupled with the entirety of foot 21. The particular placement depicted could be reversed, such that fastening means 32 is in the heel of foot 21 and fastening means 28 is in the toe of foot 20 without altering the function of the particular placement of the fastening means. Moreover, the same function could be achieved with other fastening means, such as hook-and-loop, wherein either the entirety of the bottom of the feet were covered in the fastening means, or wherein the fastening means were disposed in small quantities in the particular locations as described herein. In one preferred embodiment, fastening means 28 and 32 may be oppositely charged magnets, so that drawing the sole of foot 21 near to the sole of foot 20 engages the magnetic attraction between fastening means 28 and fastening means 32, respectively, and couples the feet in the proper position automatically. FIG. 4 depicts a similar scenario, wherein fastening means 28 and fastening means 32, having a magnetic attraction, cause feet 20 and 21, respectively, to be slightly offset when the feet are side by side. It should be understood that the polarities of the magnets depicted in FIG. 4 are exemplary, and that either magnet could be positively or negatively charged without altering the function of the magnets, so long as they are opposite from one another. It should also be understood that while disc-shaped magnets are depicted in FIG. 4, any shape of magnet could be used without altering the function of the magnets.

In a similar manner, the fastening means 22 and 23 disposed in hands 14 and 15, respectively, are designed to hold hands 14 and 15 together such that the entire surfaces of both hands are engaged. See FIG. 8 for at example, wherein the English capital letter “B” is formed by coupling hands 14 and 15 to form a top loop, and by coupling feet 20 and 21 to form a bottom loop. In some embodiments, at least one hand may be coupled with at least one foot, such as in FIG. 12, wherein one arm 12 is coupled with legs 18 to form the English capital letter “D”. In some embodiments, the fastening means on the right side of the figurine may be coupleable, such that right hand 14 is coupleable with right foot 21, etc. In other embodiments, the fastening means may be disposed such that right hand 14 is coupleable with left foot 20, and left hand 15 is coupleable with right foot 21. In any embodiment, the hand portions 14 and 15 will be coupleable, the feet portions 20 and 21 will be coupleable, and at least one hand will be coupleable with at least one foot.

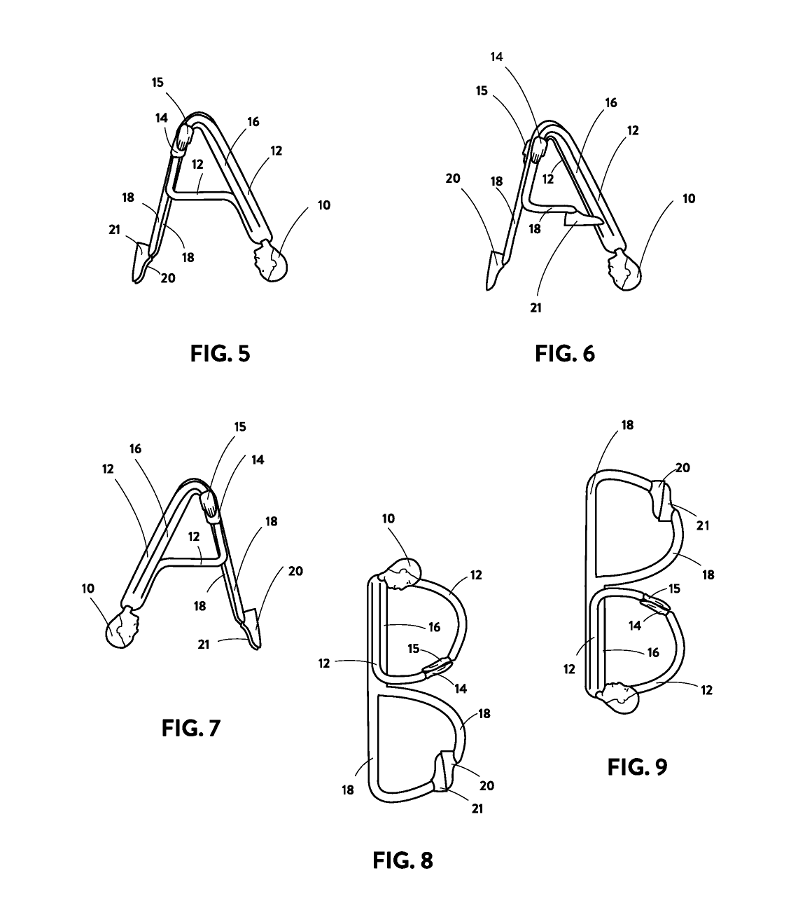

FIG. 5 through FIG. 46 are exemplary poses for the figurine 50, depicting the 26 letters of the English alphabet. These figures are meant to be exemplary and are not to be considered limiting with respect to the methods in which the figurine 50 can be posed into the various shapes of the letters. It should be understood that different methods of posing the figurine can be used to create the same shape. For instance, with respect to FIGS. 5, 6, and 7, each depicts the figurine 50 in the shape of the English capital letter “A”. However, FIG. 5 shows the bar in the letter as being formed by an arm 12, and FIG. 6 shows the bar being formed by a leg 18.

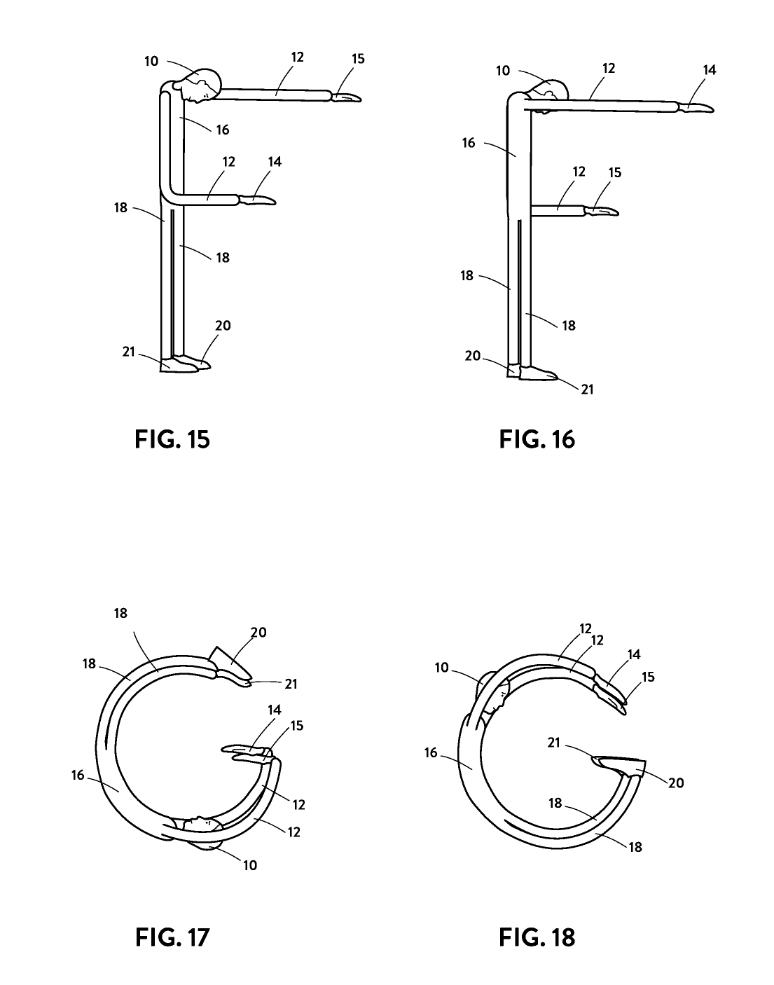

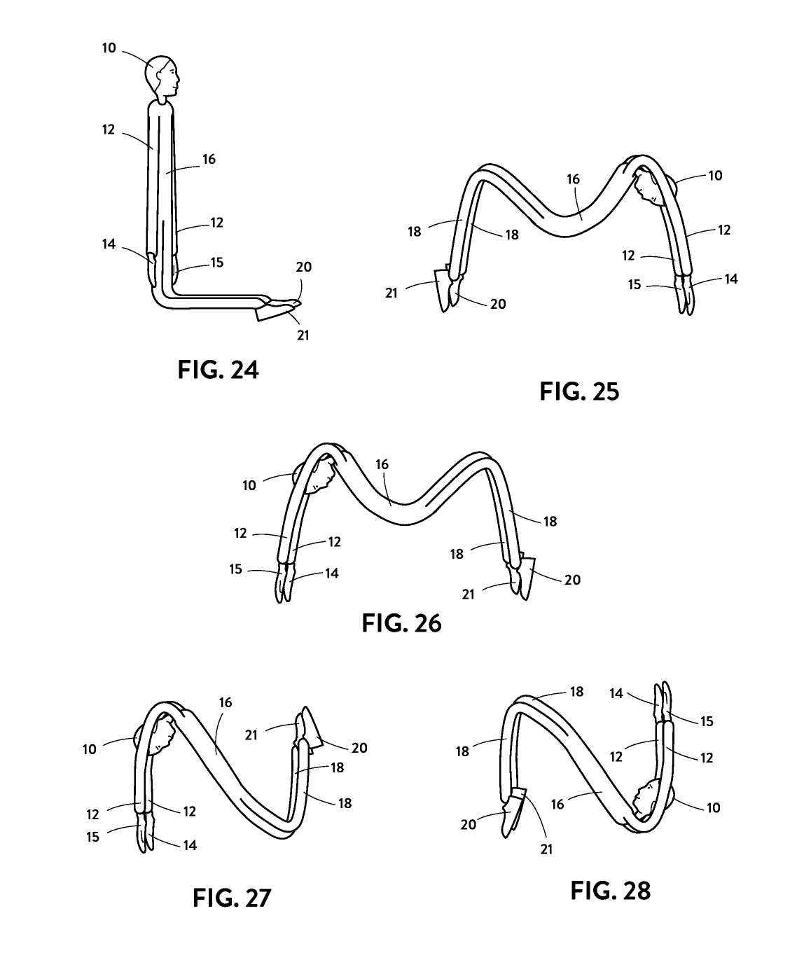

FIGS. 15, 16, and 24 are useful to show that the disproportionately long arms 12 and legs 18 serve a function with respect to the figurine. In particular, the long arms 12 and legs 18 allow letters to be formed that require long prongs, such as the letter English capital “L” in FIG. 24. Moreover, the elongated arms 12 and legs 18 allow for the formation of letters like “F”, as depicted in FIGS. 15 and 16, wherein one horizontal prong may be longer than the other. Similarly, the elongated hands 14, 15 and feet 20, 21 serve a function with respect to the figurine, which can be seen in FIGS. 17 and 18, wherein either the hands or the feet form the shelf of the English capital letter “G”. Also informative are FIGS. 32 and 33, wherein the elongated hands 14, 15 and feet 20, 21 form the tail in the English capital letter “Q”. While specific dimensions may vary based on the size of the figurine produced, it can be seen from the attached drawings that the elongated body with elongated arms 12, hand 14, 15, legs 18, and feet 20, 21 serve an important function with respect to the various shapes into which the figurine may be posed.

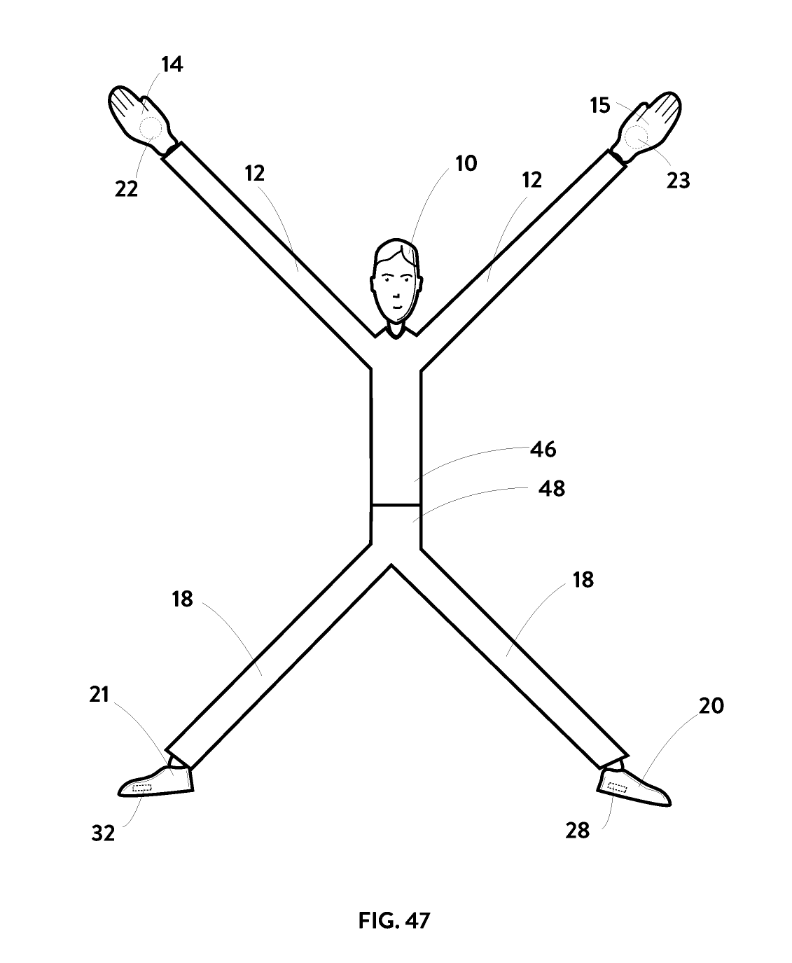

FIG. 47 is one depiction of one embodiment of the figurine wearing optional clothing. In some embodiments, the optional clothing may be comprised of a flexible material such that it bends with the figurine. Shown are a shirt portion 46 and pants portion 48 sewn to one another at the waist area, and made from material capable of bending and flexing. In a preferred embodiment, the clothing is not easily removable from the doll body. In a further embodiment, the clothing may be sewn in such a manner as to conform to the doll body shape closely and not fitting loosely, such that it cannot be grabbed and torn by children.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A figurine, comprising:
at least one head portion;
at least one body portion coupled with the at least one head portion;
at least one arm portion coupled with at least one side of the at least one body portion below the at least one head portion, the at least one arm portion including at least one magnet; and
at least one leg portion coupled with at least one side of the at least one body portion below the at least one arm portion, the at least one leg portion including at least one magnet.

2. The figurine of claim 1, further comprising:
a flexible outer material; and
a semi-flexible inner skeleton.

3. The figurine of claim 2, wherein the semi-flexible inner skeleton is disposed throughout the figurine such that the at least one head portion, at least one body portion, at least one arm portion, and at least one leg portion are independently posable.

4. The figurine of claim 1, the at least one arm portion further comprising:
at least a body end and a hand end;
at least one hand portion disposed at the hand end, wherein the at least one magnet is disposed within the hand portion of the at least one arm portion,
and wherein the at least one arm portion is coupled with the at least one body portion at the body end of the at least one arm portion.

5. The figurine of claim 1, the at least one leg portion further comprising:
at least a body end and a foot end;
at least one foot portion disposed at the foot end, wherein the at least one magnet is disposed within the foot portion of the at least one leg portion,
and wherein the at least one leg portion is coupled with the at least one body portion at the body end of the at least one leg portion.

6. The figurine of claim 1, wherein the at least one arm portion and at least one leg portion have an exaggerated length relative to the at least one body portion.

7. A figurine, comprising:
at least one head portion;
at least one body portion coupled with the at least one head portion;
at least a first arm portion coupled with at least one side of the at least one body portion below the at least one head portion, the first arm portion including at least a first magnet;
at least a second arm portion coupled with at least one side of the at least one body portion below the at least one head portion, the second arm portion including at least a second magnet, wherein the second arm portion is disposed substantially opposite the first arm portion;
at least a first leg portion coupled with at least one side of the at least one body portion below the at least one arm portion, the first leg portion including at least a first magnet; and
at least a second leg portion coupled with at least one side of the at least one body portion below the at least one arm portion, the second leg portion including at least a second magnet, wherein the second leg portion is disposed substantially opposite the first leg portion.

8. The figurine of claim 7, further comprising:
a flexible outer material; and
a semi-flexible inner skeleton.

9. The figurine of claim 8, wherein the semi-flexible inner skeleton is disposed throughout the figurine such that each of the at least one head portion, at least one body portion, first and second arm portion, and first and second leg portion are independently posable.

10. The figurine of claim 7, the first and second arm portions further comprising:
at least a body end and a hand end;
at least one hand portion disposed at the hand end of each arm portion, wherein the at least one magnet is disposed within the hand portion of each arm portion,
and wherein each arm portion is coupled with the at least one body portion at the body end of the arm portion.

11. The figurine of claim 7, the first and second leg portions further comprising:
at least a body end and a foot end;
at least one foot portion disposed at the foot end of each leg portion, wherein the at least one magnet is disposed within the foot portion of each leg portion,
and wherein each leg portion is coupled with the at least one body portion at the body end of the leg portion.

12. The figurine of claim 7, wherein each of the arm portions and each of the leg portions have an exaggerated length relative to the at least one body portion.

13. The figurine of claim 7, wherein the first hand magnet and the second hand magnet are removably coupleable.

14. The figurine of claim 7, wherein the first foot magnet and the second foot magnet are removably coupleable.

15. The figurine of claim 7, where at least one hand magnet and at least one foot magnet are removably coupleable.

16. A method of using a figurine, the method comprising:
bending a figurine with exaggerated arm and leg features into a shape that resembles at least one letter;
coupling at least one first fastener with at least one second fastener such that the figurine maintains the shape of the at least one letter.
